(19) United States
(12) Patent Application Publication
(10) Pub. No.: US 2004/0243358 A1
(43) Pub. Date: Dec. 2, 2004

(54) Method and device for determination of and imaging of an environment subjectively taken to be real by a person

(76) Inventors: Michael Schliep, Aichtal (DE); Szabolcs Toergyekes, Stuttgart (DE); Walter Zipp, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/483,186

(22) PCT Filed: Jun. 28, 2002
(86) PCT No.: PCT/EP02/07143

(30) Foreign Application Priority Data
Jul. 12, 2001 (DE) 101 33 103.7

(51) Int. Cl. G06F 15/00

(52) U.S. Cl. 702/189

(57) ABSTRACT

In order to model an environment as naturally and realistically as possible, a method and an apparatus according to the invention allow the environment to be determined as perceived by a person, that is to say largely covering all of the sensory organs. In this case, the apparatus is in the form of a multisensor integrated measurement system which is used for simultaneous recording, in a manner typical of a person, of measurement signals, such as acoustic and optical signals, light radiation signals, heat signals and smell signals, and to reproduce them authentically.

This application claims the priority of German Patent Document No. 101 33 103.7, filed Jul. 12, 2001, and PCT/EP02/07143, filed Jun. 28, 2002 the disclosure of which is expressly incorporated by reference herein, respectively.

The invention relates to a method and an apparatus for measurement and modeling of an environment, for example a vehicle environment, which is perceived subjectively by a person.

German Patent DE 197 49 588 A1 U.S. equivalent U.S. Pat. No. 6,035,720 discloses a method and an apparatus for simulation of an impression, which is perceived subjectively by an occupant of a vehicle, during operation of the vehicle, in which sound sensors which are integrated in the vehicle are provided in order to determine complaints, such as vibration oscillations or disturbing noise signals. This has the disadvantage that this apparatus allows only one vehicle-related simulation.

European Patent EP 0 357 893 A2 discloses a method for measurement of the traffic flow on roads, in which vehicles traveling past are detected and assessed by means of acoustic sensors which are arranged along the road, or by means of electrooptical sensors which are arranged outside the vehicle.

Prior art systems use a noise pattern to determine the relevant environment in the vehicle or outside the vehicle. The use of sensors which are arranged in a decentralized manner in the environment does not allow realistic recording of noises which affect the person or of other events which act on the person and can be measured.

The invention is therefore based on the object of specifying a method and an apparatus for measurement and modeling of an environment which is perceived subjectively by a person, and which apparatus models the environment as naturally and realistically as possible.

The method and the apparatus according to the invention allow the environment to be determined as perceived by a person, that is to say largely covering all of the sensory organs. In this case, the apparatus is in the form of a multisensor integrated measurement system which is used for simultaneous recording, in a manner typical of a person, of measurement signals, such as acoustic and optical signals, light radiation signals, heat signals and smell signals, and to reproduce them authentically. The measurement system advantageously has a noise measurement head (German Patent DE 35 09 376 C2), which is known from acoustic measurement technology and is designed in an anthropoid manner, combined with measurement devices, which are designed in an anthropoid manner, for optical, structure-borne sound, immission, smell and touch recording.

A quasi-humanoid multisensor measurement and reproduction system such as this allows largely natural recording and modeling, matched to the senses, of acoustic and optical impressions, perceived by the person, as well as immission or smell impressions. The noise measurement head, which is designed in an anthropoid manner, for the quasi-humanoid multisensor measurement and reproduction system for this purpose expediently has added to it further optical, structure-borne sound, immission, heat, meteorological, radioactivity, electrosmog, magnetic field, seismological and/or smell recording systems which are designed in an anthropoid manner, are linked to one another and in consequence are integrated in a measurement system.

A complex measurement system such as this furthermore allows exact association between acoustic events and relevant optical events, immission, weather, radioactivity, electrosmog, magnetic field, seismological and/or smell events.

The measurement system, which is also referred to as a quasi-humanoid multisensor measurement and reproduction system, is preferably used to record and reproduce one or more signals in parallel with an authenticity which is similar to humanoid perception.

The measurement system expediently comprises at least two noise sensors, for example microphones, which are arranged in a measurement or artificial head which is designed in an anthropoid manner. Loudspeakers, in the form of headsets and/or bass-tone loudspeakers, are also provided for reproduction of the recorded data. In addition, at least one optical measurement device, for example a stereo camera or stereo heat camera, is arranged in the eye-cavity area of the artificial head. The measurement system comprises at least one immission and/or smell sensor in order to record measurement signals which represent further sensory organs of the relevant person, such as immission and smell signals. The measurement system also comprises so-called shakers, Cyperspaces, video screens and/or heat emitters as well as convection heat, moisture, humidity, wind, smell, radiation, hazardous substance, electrosmog, magnetic field and/or radioactivity conditioning for reproduction of the recorded data. The noise sensors, the optical measurement devices and the immission and/or smell sensors are advantageously sensitive with regard to the arrangement and function of the human anatomy. This means that the measurement system is in the form of an artificial head with measurement sensors which are provided for relevant sensory organs.

Alternatively or additionally, the measurement system comprises at least one meteorological measurement device, for example a temperature, moisture, humidity, air pressure, global radiation, wind direction and/or wind speed sensor. Furthermore, sensors may be provided for recording structure-borne sound, radioactivity, electrosmog and/or seismology. Depending on the nature and function of the sensors, they may be integrated and/or arranged in and/or outside the measurement system. The measurement system is also referred to as a quasi-humanoid multisensor artificial head.

In order to process the recorded measurement signals, the quasi-humanoid multisensor measurement and reproduction system preferably has a data processing unit. In this case, the data processing unit is preferably integrated in the measurement system. Alternatively or additionally, the data processing unit is arranged separately, that is to say in an external electronic data processing unit. In this case, the data processing unit is connected to a control center, for example without the use of wires via a GSM network.

In order to assess system-dependent signals which act on the relevant person and/or can be perceived by the person, operating signals which characterize the environment are advantageously recorded, determined, analyzed and/or assessed. For example, discrete measurement variables from specific recording systems, such as a vehicle weighbridge in an observed roadway section in the area of influence of the quasi-humanoid multisensor measurement and reproduction system are recorded, and may be processed with the measurement signals recorded by the measurement and reproduction system.

Alternatively or additionally, the measurement system or the artificial measurement head has at least one opening for taking samples of immission data which is acting on the measurement system. By way of example, a [lacuna] mouth and nose openings, which are designed in an anthropoid manner, are provided in the artificial measurement head as sampling points for determination of gaseous and/or aerosol immission and/or smell loads.

For particularly realistic recording and modeling, the noise sensors are, in particular, in the form of microphones with an isotropic and/or directional characteristic and/or matching the specific directional characteristic of artificial head outer ears. The noise sensors are preferably integrated in the measurement system, that is to say in the artificial measurement head. Alternatively or additionally, they may also be arranged outside the artificial measurement head. The measurement system is expediently arranged such that it can rotate and/or such that its position can be varied. For this purpose, the artificial measurement head is arranged such that it can rotate about its vertical and/or horizontal axis. This means that the artificial measurement head can rotate laterally and/or can be moved or inclined about the trunk or head, and its vertical position can also be moved, for example with respect to its distance from the floor or ground. Depending on the nature and embodiment of the measurement system, automatic alignment is possible as a function of measurement signals which can be predetermined and/or which are currently being recorded, and which are recorded by means of measurement sensors, for example by means of acoustic, optical, immission, smell, temperature, moisture, humidity, air pressure, global radiation, wind direction, wind speed, structure-borne sound, radioactivity, electrosmog, touch and/or seismological and/or chemical sensors. In other words: the stated automatic changes to the alignment of the measurement system can be carried out as a function of acoustic, optical, immission, smell, temperature, moisture, humidity, air pressure, global radiation, wind direction, wind speed, structure-borne sound, radioactivity, electrosmog and/or seismological measurement data or signals. Depending on the nature and embodiment, the measurement data may be supplied to an open-loop and/or closed-loop control module. In this case, the open-loop and/or closed-loop control module is used, for example, to influence a traffic flow, with neural networks and/or fuzzy logic being used depending on the complexity of a process such as this.

The sensors of the measurement system are preferably calibrated by linking measurement and reproduction algorithms for individual sensors and/or for all of the sensors on the basis of empirically determined correction families of characteristics, for example in order to take account of the “perceived temperature” or “headset correction curves”.

In order to store and thus record the recorded acoustic, optical, immission, smell, temperature, moisture, humidity, air pressure, global radiation, wind direction, wind speed, structure-borne sound, radioactivity, electrosmog and/or seismological data, the measurement system has a data memory, for example a temporary dynamic or static memory. Depending on the nature and embodiment, the data memory may be integrated in the measurement system or may be in the form of a separate, external unit. For example, a dynamic or temporary memory is used in those situations in which its content comprises currently recorded measurement data for particularly realistic open-loop and/or closed-loop control. In this case, for example, currently recorded data is stored having a previous time period, for example of two minutes, which can be predetermined, and is continuously overwritten by subsequently recorded data. Alternatively or additionally, the data can be stored permanently on an event-dependent basis, for example as a function of limit values which can be predetermined for the acoustic, optical, immission, smell, temperature, moisture, humidity, air pressure, global radiation, wind direction, wind speed, structure-borne sound, radioactivity, electrosmog and/or seismological data, and/or as a function of external data.

The measurement system expediently comprises an analysis module for pattern comparison, for assessment and/or linking of recorded measurement signals, meteorological signals and/or operating signals. For example, the data recorded by internal and/or external sensors is processed using an analysis algorithm which is integrated in the analysis module. In this case, for example, the data is compared with relevant and possibly stored structure data and/or pattern data, such as data relating to a vehicle identification, voice, weight, noise or iris identification data, is identified, is associated, is stored and/or may be transmitted to other measurement systems. Artificial intelligence methods such as neural networks and/or fuzzy logic, are preferably used for looking for, identification, association and storage of significant structures and patterns.

Furthermore, data or results from individual interpretation or analysis steps are linked to one another for analysis of the measurement signals from internal and/or external sensors. A linking process such as this carried out on individual analysis results determines an underlying cause for the recorded measurement signals, that is to say an event which is currently taking place in the environment of the quasi-humanoid multisensor measurement and reproduction system. In particular, for example, the linking of the results from simultaneous video and thermal imaging analysis in order to determine the vehicle geometry, particle emissions and heat sources together with an analysis of the airborne sound and structure-borne sound which is carried out at the same time make it possible to synchronously localize the exhaust gas opening of a vehicle and, by means of concentration analysis, to identify, for example, vehicles with high exhaust gas concentrations (so-called “exhaust gas infringers”). Depending on the nature and configuration, individual prioritization of specific analysis results is possible for linking interpretation options for the individual analysis results.

In one preferred embodiment, any rolling movements of vehicle bodywork is recorded and determined by means of the measurement system, for example by means of a video analysis. This makes it possible, for example, to draw conclusions about whether the chassis or the vehicle load is wrong or correct, and whether the driver is fit to drive. The analysis of rolling movements of vehicle bodywork is carried out, for example, on the basis of a test signal. For this purpose, the test signal is introduced into the chassis, for example in the form of a transverse joint which must be driven over in a defined manner. This additionally assists the analysis of rolling movements in that the chassis is stimulated, for example, vertically in a similar manner to a dirac shock. Artificial intelligence methods, such as neural networks and/or fuzzy logic, are used for analysis of rolling movements of vehicle bodywork.

In a further preferred embodiment, a car driver who is using a mobile telephone to make a telephone call while driving is identified by means of the measurement system on the basis of linking or processing an analysis of recorded electromagnetic fields, for example of fields around mobile radios, with other signal analyses, for example with a specific video analysis. In this case, for example, the use of a mobile telephone is checked for compliance with the law, for example whether the mobile telephone is against the ear or a hands-free device is being used and, if appropriate and the law is being infringed, communicates the results of the analysis to a vehicle identification system, for example a license plate recording system. Artificial intelligence methods, such as neural networks and/or fuzzy logic, are preferably used for checking whether a driver is using a mobile telephone in accordance with the law while driving.

In order to improve the safety and/or environmental compatibility in traffic, the results of different signal analyses, for example of video and thermal imaging analysis, airborne sound and structure-borne sound analysis as well as immission analysis are logically linked, are checked for plausibility, are compared with predetermined data and/or stored if the analysis results are overshot, undershot or are complied with, and/or are transmitted to an external data recording system, data processing system and/or control system. For example, when it is dark and a light is not switched on, when a light (turn indicator, brake light) is defective, and/or if a traffic light system is driven through when red, the relevant analysis results are passed to a control center or command center, for example to a responsible authority. Artificial intelligence methods, such as neural networks, and/or fuzzy logic, are preferably used for such logic linking and for the subsequent plausibility check of various analysis results, and for comparison of analysis results with predetermined data, in order to improve safety and/or environmental compatibility.

In order to identify objects and people as well and quickly as possible, for example for access control systems such as the so-called “electronic gatekeeper”, the results of signal analyses, such as video and thermal imaging analysis, noise analysis, analysis of biometric data (for example fingerprints, face, irises, voice, body smell and breathing smell, alcohol content of the breath), magnetic and/or optical analysis of passes and/or freight bills and/or vehicle parts, for example license plate, and weight analyses are logically linked, are checked for plausibility and/or are compared with predetermined data by means of the measurement system. If appropriate, for example in the event of an overshoot or undershoot or in the event of a match, the analysis results are stored and/or are communicated to an external data recording system, data processing system and/or control system. Artificial intelligence methods, such as neural networks and/or fuzzy logic are used for logic linking and for plausibility checking of the analysis results, as well as for the comparison of the analysis results with predetermined data in order to improve the hit probability for an associated automatic identification of an object or person.

The measurement system is advantageously connected to an adjacent measurement system for interchanging relevant measurement signals, meteorological signals and/or operating signals.

A network such as this which comprises two or more quasi-humanoid multisensor measurement and reproduction systems which communicate with one another in this case allows, in particular, continuous monitoring and tracking of a vehicle, and/or of a person and/or of any other desired moving and/or stationary object, for example of a container over a recording field, for example a road network or a factory site. In this case, for example, speeds and driving times for drivers of a particular route can be determined, and toll fees can be paid without any intermediate stop.

In a further preferred embodiment of the quasi-humanoid multisensor measurement and reproduction system, a serviceability check, a search for faults or fault analysis is carried out, for example, for vehicles, in order, for example, to detect hazardous exhaust gas concentrations in the interior of the vehicle resulting from a leakage in the exhaust gas manifold or, for example, a defective hydraulic ram. Further vehicle data, such as the camshaft position, can be taken into account in the fault analysis, if appropriate in real time, via an interface, for example an optical interface, with the vehicle being stationary or during test drives.

The respective measurement system is expediently used to store the data which is recorded by internal and/or external sensors as well as the data which is evaluated during the signal analysis, and/or to pass such data on to external systems, such as data recording systems, data processing systems and/or control systems. The measurement system preferably communicates bidirectionally with an adjacent measurement system and/or with a control center, that is to say the measurement system can receive information, data and/or control signals from external data recording systems, data processing systems and/or control systems. This ensures that the influence of adjacent measurement systems is taken into account during analyses in the measurement system.

### BRIEF DESCRIPTION OF THE DRAWINGS

Exemplary embodiments of the invention will be explained in more detail with reference to the drawing, in which:

FIG. 1 shows, schematically, an apparatus for measurement and modeling of an environment which is perceived subjectively by a person,

FIG. 2 shows, schematically, an evaluation unit for the apparatus shown in FIG. 1,

FIG. 3 shows, schematically, an apparatus which is designed in an anthropoid manner as shown in FIG. 1, and

FIGS. 4-9 show various application options for the apparatus shown in FIG. 1.

### DETAILED DESCRIPTION OF THE PREFERRED EMBODIMENTS

Mutually corresponding parts are provided with the same reference symbols in all of the figures.

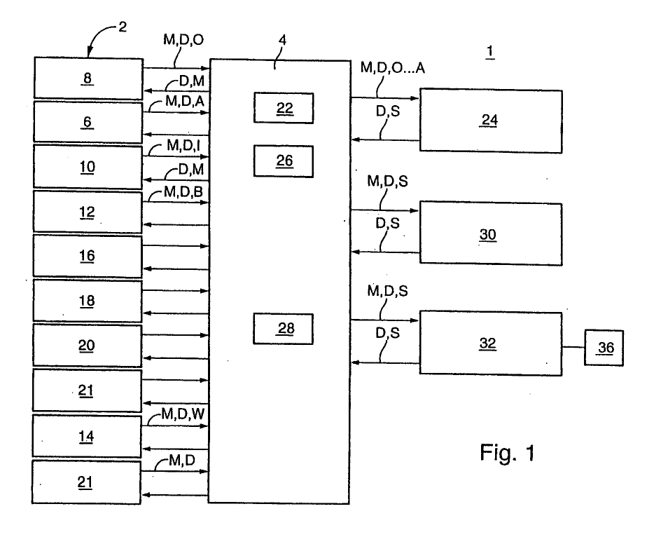

FIG. 1 shows an apparatus 1 for measurement and modeling of an environment U which is perceived subjectively by a person P. The apparatus 1, which is also referred to as a measurement and reproduction system, comprises a multisensor measurement system 2 for recording, and an evaluation unit 4 for determination of two or more measurement signals M which characterize the environment U and can be perceived by the person P.

The multisensor measurement system 2 has a measurement sensor system appropriate for the physical variables which act on the sensory organs of the person P. In this case, optical signals O, acoustic signals A, immission signals I and/or smell signals G are recorded as measurement signals M by means of the measurement system 2. For this purpose, the measurement system 2 comprises at least two noise sensors 6 for recording and reproduction of the auditory sense of the person P, at least one optical measurement device 8 for recording and reproduction of the visual acuity of the person P, at least one immission sensor 10 for recording and reproduction of immissions that act on the person P, and/or at least one smell sensor 12 for recording and reproduction of the sense of smell of the person P.

Alternatively or additionally, the measurement system 2 may comprise further sensors, which are represented by dashed lines in FIG. 1, for recording and determination of meteorological signals W which characterize the environment U, and/or operating signals B, for example at least one meteorological measurement device 14, at least one hazardous substance sensor 16, at least one radioactivity sensor 18 and/or at least one electrosmog sensor 20 and/or at least one sensor for seismology 21 and/or for touch.

Depending on the nature and function of the apparatus 1, the measurement signals M, the meteorological signals W and/or the operating signals B are determined preferably in real time and thus in parallel, and are linked to one another, by means of the evaluation unit 4, to comply with the relevant requirements. Alternatively, the signals may also be recorded and determined separately or only on request and thus on an event-controlled basis, for example when a limit value is exceeded. For this purpose, the evaluation unit 4 has at least one analysis module 22 for pattern comparison, for assessment and/or for linking the measurement signals M, the meteorological signals W and/or the operating signals B. Depending on the requirement, the analysis module 22 is used to process currently detected signals and/or previous signals which are stored in a data memory 24, and/or patterns which represent the signals.

The evaluation unit 4 furthermore comprises a test module 26 for plausibility checking and/or an open-loop and/or closed-loop control module 28 for influencing the environment U, in particular for influencing a traffic flow, as a function of the measurement signals M, meteorological signals W and/or operating signals B which are recorded by means of the measurement system 2. For this purpose, the evaluation unit 4 is connected to a control center or command center 34, or to drive units 36, such as a motor, by means of a communication module 30, for example a modem, and/or by means of a drive module 32.

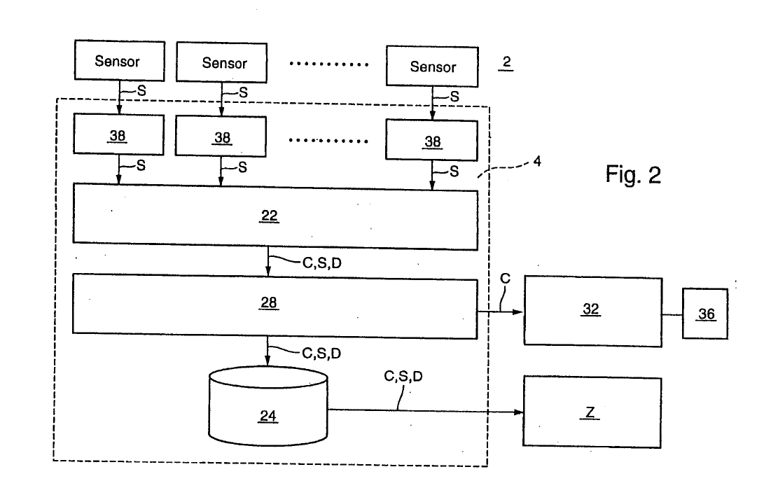

FIG. 2 illustrates the evaluation unit 4 shown in FIG. 1, in more detail. The signals S which are recorded by the measurement system 2 are supplied to an associated measurement value conditioning module 38, depending on the signal type and/or function. The signals S are then processed and, if appropriate, linked to one another, by means of the analysis module 22 in order to form control signals C. The control signals C are supplied to the open-loop and/or closed-loop control module 28 in order to control the drive units 36. Depending on the requirement, the signals S, the control signals C and/or intermediate results may be stored in the data memory 24. For this purpose, the data memory 24 has signal-dependent memory areas, with the relevant signals S being stored as a function of the signal type in a dynamic memory area, which is overwritten after a period of time, and/or in static memory areas for archiving. The signals S which are stored as data D in the data memory 24 may be passed on to external systems, for example to a command center, to a control center Z or to a toll station, for example by means of the Internet or, for example, by means of a tie line.

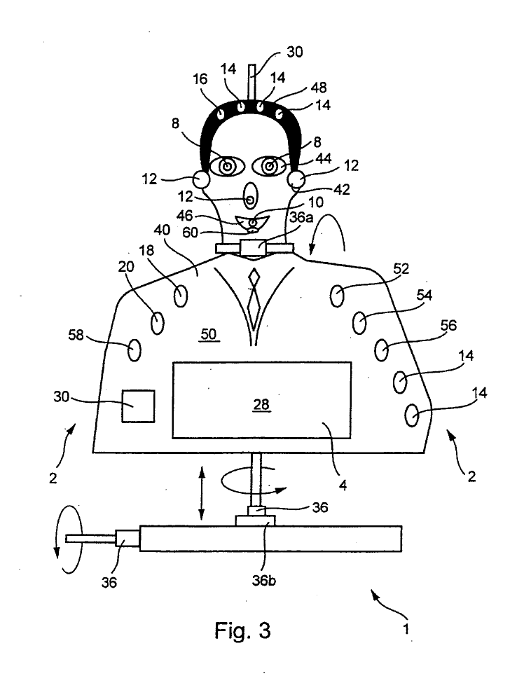

FIG. 3 shows one embodiment of the apparatus 1. The apparatus 1 comprises the integrated measurement system 2, which is provided for simultaneous recording, as perceived by a person, of acoustic signals A and optical signals O, immission signals I as well as heat and smell signals G together with radioactivity signals, electrosmog signals, magnetic field signals, seismology signals and/or meteorological signals, and their authentic reproduction by means of the evaluation unit 4.

The geometrical configuration of the apparatus 1 is in this case modeled at least on a human body part 40, for example an upper body. In this case, the noise sensors 12, for example microphones, are arranged in outer ears 42 that are formed, the optical measurement device 8, for example a stereo camera or a stereo heat camera, is arranged in eye cavities 44 that are formed, the immission sensor 10 is arranged in a model of the mouth opening 46, and the smell sensor 12 is arranged in a model of the nasal cavities. The arrangement and configuration of the sensors on the measurement system 2 are in this case matched to the respective function and position of the sensory organs of the person P and to the respective environment U to be monitored, and may be varied.

An apparatus 1 of this type which is designed in an anthropoid manner allows particularly realistic and natural optical, structure-borne sound, immission and smell recording, as well as radioactivity, electrosmog, magnetic field, seismology and/or meteorological recording. A quasi-humanoid multisensor measurement and reproduction system such as this allows the acoustic impressions, which are recorded in a similar way to human beings, to have added to them the associated optical, immission or smell impressions, or meteorological impressions, which are likewise recorded in a similar manner to human beings. The logical linking process on which the quasi-humanoid multisensor measurement and reproduction system is based between the measurement head, which is constructed to be similar to a human being, and the optical structure-borne sound, immission, smell, radioactivity, electrosmog, magnetic field, seismographic and meteorological recording systems, which are designed to be similar to human beings, allows simultaneous recording and reproduction, as perceived by a human being, of acoustic, optical, immission, smell, radioactive, electrosmog, magnetic field, seismographic and meteorological events. This also allows, for example, exact association between acoustic events and the matching optical, immission, smell, radioactivity, electrosmog, magnetic field, seismographic and meteorological events, and operating data from external systems.

In addition, the apparatus 1 also has sensors which relate to the person P and to the environment U, such as the precipitation or hazardous substance sensor 16 and the meteorological measurement device 14, for example a wind direction sensor, a wind speed sensor, and a light radiation sensor, which are arranged at appropriate positions, for example on the head 48, depending on their function. Furthermore, the radioactivity sensor 18 and/or the electrosmog sensor 20 are/is arranged close to the chest 50. Depending on the nature and requirement, a temperature sensor 52, an air pressure sensor 54, a moisture or humidity sensor 56, an arrangement of structure-borne sound sensors 58 for recording oscillations in all degrees of freedom and for seismological recordings and/or a speech sensor 60 may be provided at relative positions, depending on the function, of the body part 40.

The evaluation unit 4 is integrated in the interior of the body part 40 and is thus arranged particularly securely for protection against external influences, and is connected to the sensors of the measurement system 2 with and/or without the use of wires. For communication with the control center Z or with adjacent autonomous apparatuses 1, the body part 40 has the communication module 30, for example an antenna, in a position where reception is good, in particular on the head 48. Depending on the field of application of the apparatus 1, this apparatus is arranged such that it can rotate and/or such that its position can be varied. For this purpose, the apparatus 1 has at least one drive unit 36, for example a motor 36a in the neck area 62 for head inclination and/or rotation, a motor 36b in the spinal column area 64 for trunk inclination, for rotary movement, for sideways movement and/or for vertical movement. The open-loop and/or closed-loop control module 28 is used to control the motors 36a to 36b automatically, on an event-controlled basis or manually as a function of signals recorded by the measurement system 2, with the apparatus 1 accordingly being moved in a corresponding manner and being aligned appropriately for the measurement task.

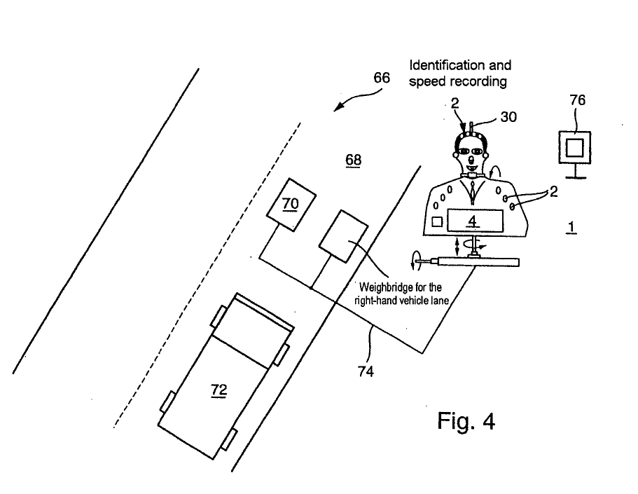

FIG. 4 shows one possible field of application of the apparatus 1 for vehicle monitoring, in particular for monitoring for a maximum permissible vehicle weight, for a maximum permissible axle load and/or for a maximum permissible vehicle load. For this purpose, the apparatus 1, which is also referred to as a quasi-humanoid multisensor measurement and reproduction system, is arranged on a road 66 in whose roadway 68 at least one weighbridge 70 is installed for measurement in one vehicle lane, for example of the individual force on the left-hand or right-hand side of a vehicle 72 traveling over it. In this case, the measurement system 2 of the apparatus 1 is used to record optical signals O, acoustic signals A, immission signals I and/or operating signals B for the vehicle 72 driving past, which are processed and assessed by means of the evaluation unit 4 on the basis of the analysis module. Furthermore, the weight as recorded by means of the weighbridge 70, in particular the distribution on the lanes and axles, is supplied via a data transmission unit 74 to the evaluation unit 4 for linking to the signals recorded by means of the measurement system 2. On the basis of the recorded and supplied measurement signals M, operating signals B and further signals such as the weight, data is emitted to the control center Z relating to the speed, the noise emission and weight as well as relating to the vehicle type, the correct loading (on one side or overloading, or exceeding of the maximum permissible axle load), vehicle identification, a vehicle height, and emission, via an output unit 76, for example a screen, by means of the evaluation unit 4 or by means of the communication module 30. The recorded signals and/or the assessed data are/is, furthermore, stored in the data memory 24. Any overshoots of maximum permissible values may, furthermore, be communicated to other systems, and may be stored.

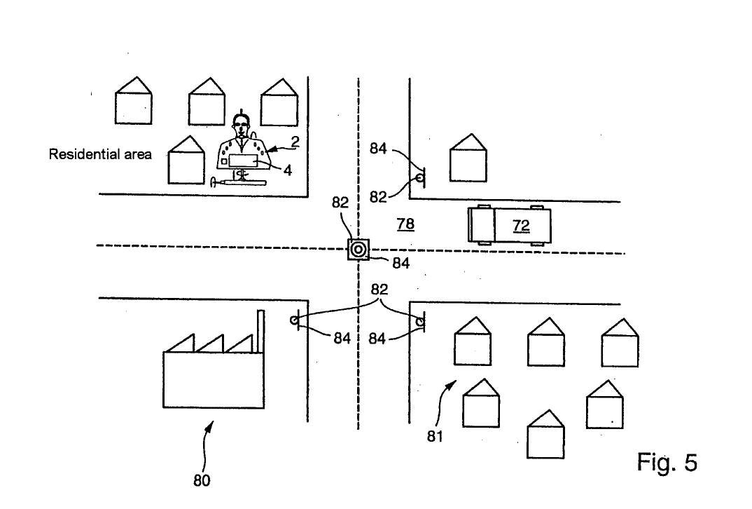

Alternatively or additionally, the position of the apparatus 1 may be varied as a function of recorded signals. For example, as is shown in FIG. 5, the apparatus 1 is arranged at a busy road junction 78 at the edge of an industrial site 80 which emits noise, and at the edge of residential areas 81. This road junction 78 is subject to a periodically varying, severe, city traffic load, as well as an industrial load. In this case, the apparatus 1 is positioned in the direction of the industrial site 80, and thus in the noise incidence direction. If, for example, the measurement system 2 records a noise level, for example from the very noisy vehicle 72 driving past, which is above a value which can be predetermined, the incidence direction of the sound is determined by means of the evaluation unit 4 on the basis of the acoustic analysis of the recorded sound, and the apparatus 1, which is also referred to as an artificial head or artificial body structure, is automatically rotated or inclined with the acoustic, optical, immission, smell, temperature, moisture, humidity, air pressure, global radiation, wind direction, wind speed, structure-borne sound, radioactivity, electrosmog and/or seismological sensors automatically such that the apparatus 1 is pointing at the main incidence direction of the sound that dominates the overall noise pattern, that is to say from the vehicle 72 that is driving past. Possible alignments of the apparatus 1 are indicated by arrows in the FIGS. 3, 4 and 5. In this case, the noise signal or acoustic signal A is recorded not only by the noise sensors 12 of the apparatus 1 but also by external measurement systems 82 which are arranged in the vicinity U, such as noise detectors 84. Furthermore, the apparatus 1 can communicate with further measurement systems 82 which are arranged in the vicinity U, for example with a wide-angle camera 84 for a high-level recording system.

In other words: the evaluation unit 1 is used to evaluate the recorded and/or received signals, on the basis of which the moving noise source is identified and is associated with the moving vehicle 72. Depending on the requirement, the apparatus 1 may be rotated or moved into the incidence direction of the received sound, and thus into the direction of the vehicle 72, if a maximum permissible limit value for the noise level is exceeded. Alternatively, the apparatus 1 may also be aligned as a function of other recorded signals, for example on the basis of the wind direction or to follow a vehicle 72 which is driving past.

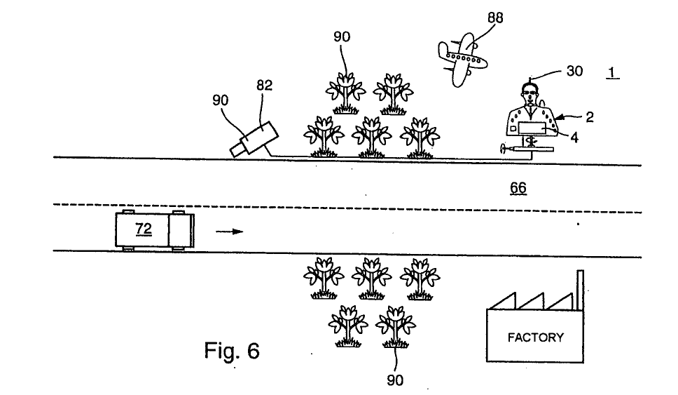

FIG. 6 shows a further field of application for the apparatus 1 for prioritization of various analysis results by assessment, association and linking. In this case, the apparatus 1 is arranged on a road 66. A vehicle 72 producing severe sooty emissions approaches the apparatus 1 that is monitoring the area U. A low-flying aircraft 88 masks out the sound of the noise caused by the vehicle 72. Owing to the trees 90 between the vehicle 72 and the apparatus 1, the vehicle 72 cannot yet be recorded optically by the apparatus 1. In order to record objects which are already loading the area U acoustically and by emissions, which, however, cannot yet be recorded optically by the apparatus 1, the apparatus 1 is connected to further measurement systems 82, for example a monitoring camera 90. The monitoring camera 90 also has a thermal imaging camera. The vehicle 72 is thus recorded by means of the external monitoring camera 90 even before it reaches the optical detection area of the apparatus 1. Depending on the nature and configuration of the monitoring camera 90, the emission of hazardous substances caused by the vehicle 72 is detected on the basis of the smoke plume, and is transmitted to the evaluation unit 4 by means of the communication module 30.

In addition to the recording, determination and assessment of the vehicle 72, the evaluation unit 4 detects the aircraft 88 on the basis of a pattern comparison of the noise level recorded from the aircraft 88 and the noise incidence direction, and identifies this as a brief noise source which is of minor importance for the area U to be monitored. In other words: the evaluation unit 4 uses the analysis module 22 to prioritize measurement signals which are recorded at the same time from different objects. In order to prevent hazardous substance emissions or sound emissions which are above the limit values, the vehicle 72 is therefore continuously monitored for compliance with the limit values by appropriate alignment of the apparatus 1 in the direction of the vehicle 72. Depending on the nature and the embodiment, if the limit values are exceeded, the vehicle 72 can be prevented from driving further by appropriate measures and via a command center or by a monitoring station, or can receive an appropriate message in the form of communication, for example “hazardous substance emission too high—carry out ASU”.

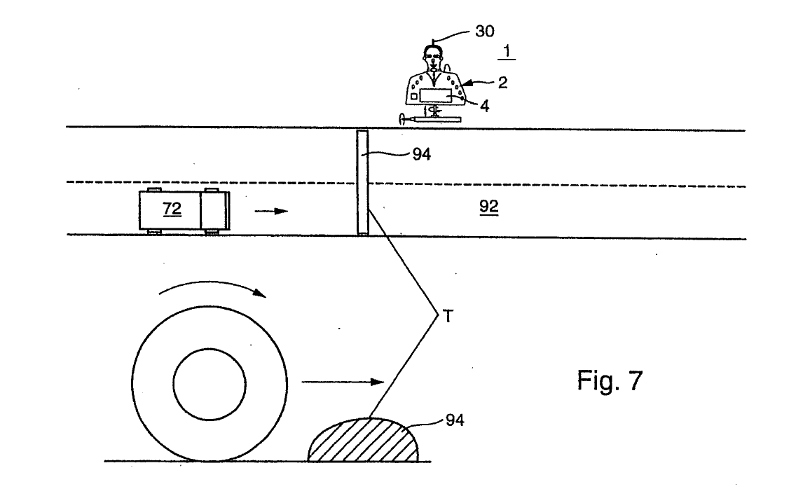

FIG. 7 shows a further field of application for the apparatus 1 for analysis of rolling movements of the vehicle bodywork. For this purpose, the apparatus 1 is arranged on a test route 92. The vehicle 72 is tested, for example, for operation of the shock absorbers. For this purpose, the roadway 68 has a transverse joint 94. On driving over the transverse joint 94, a defined test signal T is applied to the vehicle 72. The speed of the vehicle 72 is determined on the basis of a video analysis by means of the measurement system 2 and the evaluation unit 4 in the apparatus 1. The oscillatory movement of the vehicle 72 which results from the stimulus produced by the transverse joint 94 that is driven over is compared on the basis of the video analysis with vehicle-specific oscillation reference patterns which are stored in the data memory 24. The comparison result is supplied for information, control and maintenance purposes to the data memory 24, to the open-loop and/or closed-loop control module 28 and to the communication module 30.

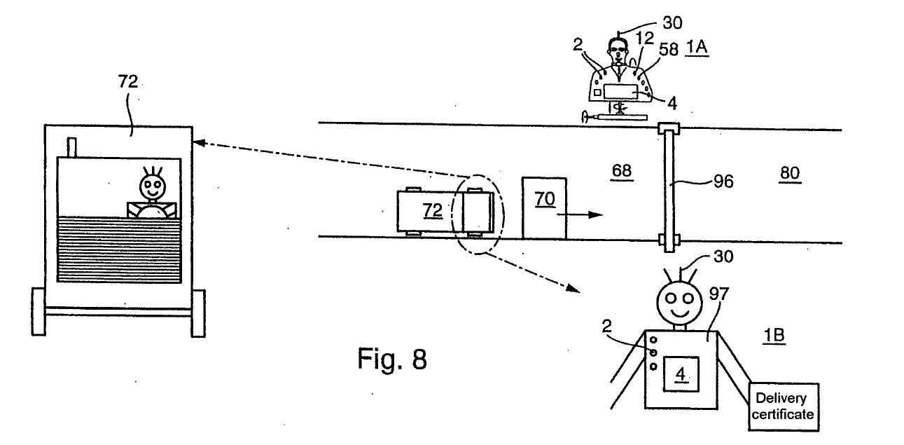

FIG. 8 shows a further field of application for the apparatus 1 for use as an “electrical gatekeeper”. In this case, the apparatus 1A is used for automatic vehicle, personnel and/or goods identification. For this purpose, the apparatus 1A is arranged adjacent to a barrier 96 to the industrial site 80. The vehicle 72 drives over the weighbridge 70, which is arranged in the roadway 68, into the detection area of the apparatus 1A. The apparatus 1A carries out an image analysis, in order to record and determine the vehicle identification, and to analyze the vehicle type and vehicle color. The vehicle drive is recorded and analyzed by means of the measurement system 2 and by means of further noise sensors 12 and structure-borne sound sensors 58 on the basis of an airborne sound and structure-borne sound analysis. Furthermore, the technical conditions of the vehicle 72 is checked by means of the apparatus 1 on the basis of a video, thermal imaging, noise and immission analysis, for example relating to the temperature of the brakes, the condition of the tires, the condition of the shock absorbers, and the noise and exhaust gas emissions. Furthermore, the apparatus 1A carries out a radioactivity, electrosmog and immission analysis in order to check the vehicle 72 for radioactivity, smuggled goods and/or illegal immigrants. In addition, the load state of the vehicle 72 is monitored and checked on the basis of an image analysis by means of the apparatus 1, and the vehicle 72 is monitored and checked for one-sided loading and/or for overloading by means of the weighbridge 70. Depending on the requirement and the analysis result, the barrier 96 is opened in order to drive onto the industrial site 80. If not, information relating to the vehicle 72 is sent to the control center Z by means of the communication module 30 in the apparatus 1A.

In the case of automatic personnel and goods identification, the apparatus 1B furthermore has a fingerprint module 97, which is not shown in any more detail, for fingerprint analysis. Furthermore, the analysis module 22 has further functions added to it, for example face identification, iris identification or pass identification by means of image analysis, or voice identification by means of noise analysis. Alternatively or additionally, the pass identification process can also be carried out by means of an electrosmog or magnetic field analysis. Relevant measurement sensors and/or software modules are accordingly added to the measurement system 2 and to the evaluation unit 4 for the apparatus 1B. In order to check a goods delivery a delivery certificate can be identified by means of the apparatus 1B on the basis of an image analysis, an electrosmog analysis and/or a magnetic field analysis.

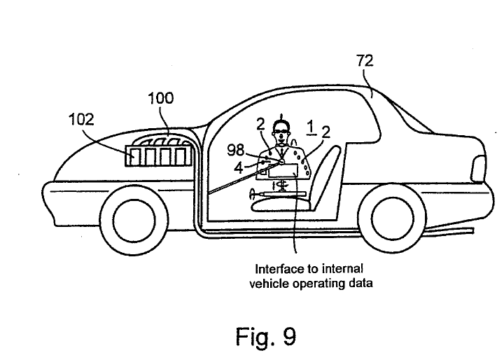

FIG. 9 shows a further field of application for the apparatus 1 for use as a mobile fault analysis apparatus, which is also referred to as the “mobile fault spy”. In this case, the apparatus 1 is used for serviceability monitoring, for fault localization and for fault analysis of vehicles 72. By way of example, the vehicle 72 is in a workshop or is being driven on a test track, and is connected via a data interface 98 to the quasi-humanoid multisensor measurement and reproduction system 1 which, for example, is arranged on the front passenger's seat. By way of example, the vehicle 72 has a leakage from the exhaust gas manifold 100, whose exhaust gas is entering the interior of the vehicle via the ventilation system. Exhaust gas immission resulting from this by a vehicle occupant is determined by means of the apparatus 1 on the basis of the recording of exhaust gas concentrations in the area of typical nose and mouth positions of occupants, that is to say in the nose and mouth area of the quasi-humanoid multisensor measurement and reproduction system.

In addition, one cylinder 102 of the vehicle 72 may be producing a conspicuous noise. The quasi-humanoid multisensor measurement and reproduction system 1 can identify the relevant cylinder 102, and in particular can determine its camshaft position, on the basis of a noise analysis and on the basis of the operating data B which is transmitted via the data interface 98. In a further application of the quasi-humanoid multisensor measurement and reproduction system 1, the gas pedal and the brake in the vehicle 72 are driven by means of the apparatus 1 such that a predetermined engine load is maintained at a constant speed. Furthermore, specific engine loads can now be predetermined without brake control. The apparatus 1 is in this case used firstly to control the vehicle and secondly, by means of the apparatus 1, to monitor, analyze and/or if necessary to link to one another currently recorded measurement signals M and operating signals B, as a function of the predetermined control.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. (Cancelled)

2. The method as claimed in claim 32, wherein said characterizing signals include at least one of optical, acoustic, immission smell and touch signals.

3. The method as claimed in claim 32, wherein meteorological signals, radioactivity signals, electrosmog signals, magnetic field signals and/or seismological signals which characterize the environment are recorded and determined.

4. The method as claimed in claim 3, wherein operating signals which characterize the environment are recorded and determined.

5. The method as claimed in claim 4, wherein the characterizing signals, the meteorological signals, radioactivity signals, electrosmog signals, magnetic field signals, seismological signals and the operating signals are recorded and determined jointly or separately.

6. The method as claimed in claim 4, wherein the characterizing signals, the meteorological signals, radioactivity signals, electrosmog signals, magnetic field signals, seismological signals and the operating signals are analyzed and assessed by means of a pattern comparison.

7. The method as claimed in claim 4, wherein the characterizing signals, the meteorological signals, radioactivity signals, electrosmog signals, magnetic field signals, seismological signals and the operating signals are linked and assessed.

8. The method as claimed in claim 32, wherein discrete measurement variables (M) from specific recording systems, are recorded and taken into account in a roadway section that is to be monitored, by means of a quasihumanoid multisensor measurement and reproduction system.

9. The method as claimed claim 8, wherein data which is recorded by means of the multisensor measurement and reproduction system (1) is processed, analyzed, compared, assessed and linked on the basis of neural networks or fuzzy logic.

10. The method as claimed claim 32, wherein at least one of an open-loop and closed-loop control process and/or signal analysis is supported by neural networks or fuzzy logic.

11. The method as claimed in claim 32, wherein a temporary memory is used to record acoustic, optical, immission, smell, temperature, moisture, humidity, air pressure, light radiation, wind direction, wind speed, structure-borne sound, radioactivity, electrosmog, magnetic field and/or seismological data, a content of which temporary memory is retained such that an open-loop or closed-loop control process initiates the retention of the currently recorded data as a function of the recorded data or as a function of external data.

12. The method as claimed in significant structures and patterns including at least one of vehicle identification, a voice identification, a weight or iris identification, are detected, associated, stored or transmitted to other systems by means of analysis of the data which is recorded by internal and external sensors.

13. The method as claimed in claim 32, wherein artificial intelligence methods, including at least one of neural networks and fuzzy logic, are used for, detection, association and storage of significant structures and patterns.

14. The method as claimed in claim 32, wherein interpretation options for individual analysis results are linked during analysis of recorded data from internal or external sensors are linked to one another in order to determine the basic cause which is common to all the recorded data.

15. The method as claimed in claim 32, wherein relevant analysis results are prioritized for the linking of interpretation options for individual analysis results.

16. The method as claimed in claim 32, wherein rolling movements of a vehicle are recorded by video analysis and are assessed with regard to the vehicle state, the vehicle load or whether the driver is fit to drive.

17. The method as claimed in claim 16, wherein the analysis of rolling movements of vehicle bodywork is assisted by the introduction of a test signal which causes a chassis to move vertically.

18. The method as claimed in claim 32, wherein a vehicle, a container or a person is monitored using a network, which comprises quasi-humanoid multisensor measurement and reproduction systems which communicate with one another, in a predetermined recording area of a road network or on a factory site, with regard to movement or operating parameters.

19. (Cancelled)

20. The apparatus as claimed in claim 33, wherein a geometrical configuration of the measurement sensors models at least one human body part and comprises at least two noise sensors as well as at least one further sensor for recording of data light signal immissions, noise, touching, meteorology, radioactivity, electrosmog, magnetic field or seismology.

21. The apparatus as claimed in claim 33, further comprising at least one opening for taking samples of immission data.

22. The apparatus as claimed in claim 33, wherein the measurement sensors are arranged such that their position can be varied.

23. The apparatus as claimed claim 33, wherein an alignment, inclination or position of the measurement sensors can be varied as a function of the recorded output signals, optical signals, acoustic signals, meteorological signals, immission signals, smell signals, radioactivity signals, electrosmog signals, magnetic field signals, seismic or touch signals.

24. The apparatus as claimed in claim 23, further comprising a data memory for recording and storage of the output signals, of the meteorological signals, of the operating signals, of the radioactivity signals, of the electrosmog signals, of the magnetic field signals, of the seismological signals or of the touch signals.

25. The apparatus as claimed in claim 33, wherein the analyzing means including an analysis module is provided for pattern comparison, assessment or linking of the recorded measurement signals, meteorological signals, operating signals or data.

26. The apparatus as claimed in claim 33, further including at least one of an open-loop and closed-loop control module for influencing a traffic flow, as a function of the output signals, meteorological signals, operating signals or data which are recorded.

27. The apparatus as claimed in open-loop or closed-loop control module for limiting currently recorded signal values which are above or below predetermined limit values.

28. The apparatus as claimed in claim 33, further including a test module for plausibility checking.

29. The apparatus as claimed in claim 33, further including a control center.

30. The apparatus as claimed in claim 33, further including an adjacent measurement system for interchanging relevant measurement signals, meteorological signals, operating signals or data.

31. The apparatus as claimed in an arrangements for reproduction of recorded signals including, loudspeakers, an apparatus for multidimensional representation, video screens, signal mixers, heat emitters or arrangements for convention heat, moisture, humidity, wind, smell, radiation, hazardous substance, electrosmog, magnetic field or radioactivity conditioning.

32. A method for measuring and modeling an environment perceived by a person, said method comprising:
measuring a plurality of characterizing signals wherein said characterizing signals correspond to sensory perception of the person; and
recording and analyzing said characterizing signals.

33. An apparatus for measuring and modeling of a subjective perception of an environment by a person, said apparatus comprising:
a plurality of measuring sensors for measuring a corresponding plurality of input representing sensory perceptions of the person;
analyzing means for receiving output signals from said plurality of sensors for recording, analyzing and determining a characterization of an environment perceived by the person.
